(19) United States
(12) Patent Application Publication
(10) Pub. No.: US 2013/0214103 A1
(43) Pub. Date: Aug. 22, 2013

(54) FOLDABLE BABY CARRIER SUPPORT

(71) Applicants: TSE-CHIEN WU, Kaohsiung City (TW); YUNG-SHUEN LIN, Chiayi County (TW); SHAN-HENG LIN, Chiayi County (TW); KUANG-NENG CHENG, Chiayi County (TW)

(72) Inventors: TSE-CHIEN WU, Kaohsiung City (TW); YUNG-SHUEN LIN, Chiayi County (TW); SHAN-HENG LIN, Chiayi County (TW); KUANG-NENG CHENG, Chiayi County (TW)

(73) Assignee: LERADO(ZHONG SHAN)INDUSTRIAL CO., LTD, Zhong Shan City (CN)

(21) Appl. No.: 13/771,785

(22) Filed: Feb. 20, 2013

(30) Foreign Application Priority Data
Feb. 21, 2012 (CN) 201220056160.4
Jul. 18, 2012 (CN) 201220348510.4

(51) Int. Cl. F16M 11/38

(52) U.S. Cl. CPC F16M 11/38
USPC 248/129

(57) ABSTRACT

A foldable baby carrier support includes a front rack, a rear rack and a locking mechanism. The front rack has a pair of front side struts extending through a front side of the foldable baby carrier support; the pair of front side struts each has a rear downward extension bended from the front side to the rear side of the foldable baby carrier support, and the rear downward extensions each has a pivot portion at its distal end. The rear rack includes a pair of rear side struts, each being equipped with a pivot mounts for pivoting the rear downward extensions at the pivot portions. The locking mechanism is adopted to lock and unlock the pivot mounts so as to lock the foldable baby carrier support in an erected configuration, and unlock the foldable baby carrier support to be foldable into a folded configuration.

### BACKGROUND OF THE INVENTION

1. Field of the Invention

The present invention relates to a baby carrier support, especially to a foldable baby carrier support that has special arrangement to pivot portion and could be safely manipulated to fold for storage and erecting to use.

2. Description of the Related Art

Baby carrier, such as baby seat, bassinet, portable car seat, high chair, etc., are normally adopted in different ages from baby to children, for adjustment of height they always needed to have a support for connecting under the baby carrier.

One of known high chairs as disclosed in CN Patent Filing Number 201120002470.3 (now Patent Number CN 201961354 U), which includes a support frame assembled with a front frame and rear frame pivoted together that can be folded to overlap to each other; however when user folding the frame, as the edges between the frames are so sharp, that may cause user's hand and fingers got cut or clamped accidently during the daily folding manipulations.

Another example for known baby carrier with support means as being disclosed in CN Patent Filing Number 201020549452.2 (now Patent Number CN 201831400 U), is a baby seat characterized by having an adjustable mechanism, by which can change the distance between its food plate and seatback for playing toys and feeding foods of the baby; however, user cant not adjust the height of the baby seat as needed for use, transportation and storage.

### SUMMARY OF THE INVENTION

In order to provide a more safe and adjustable in height for baby carrier support, the present invention provides a foldable baby carrier support, which may include a front rack, a rear rack and a locking mechanism.

The front rack has a pair of front side struts extending through a front side of the foldable baby carrier support; the pair of front side struts each has a rear downward extension bended from the front side to the rear side of the foldable baby carrier support, and the rear downward extensions each has a pivot portion at its distal end.

The rear rack includes a pair of rear side struts, each being equipped with a pivot mounts for pivoting the rear downward extensions at the pivot portions. The locking mechanism is adopted to lock and unlock the pivot mounts so as to lock the foldable baby carrier support in an erected configuration, and unlock the foldable baby carrier support to be foldable into a folded configuration.

As the rear downward extension is bended from the front side to the rear side, the pivot point has a distance from the front rack, that could use to prevent the front rack and the rear rack from clamping like a scissors to cut the user's hand and fingers.

### BRIEF DESCRIPTION OF THE DRAWINGS

The accompanying drawings, which are included to provide a further understanding of the invention are incorporated in and constitute a part of this specification, illustrate embodiments of the invention and together with the description serve to explain the principles of the invention. In the drawings:

FIG. 1 is a front-left perspective view for showing a seat operatively mounted on an embodiment of the foldable baby carrier support according to the present invention.

FIG. 2 is a front-left perspective view for showing an embodiment of the foldable baby carrier support according to the present invention.

FIG. 3 is an exploded perspective view showing a locking mechanism of the foldable baby carrier support according to the present invention.

FIG. 4 is a partially cut-off perspective view for showing the assembly of the locking mechanism according to the present invention.

FIG. 5 is a schematic perspective view showing the manipulation of the locking mechanism of the present invention.

FIG. 6 is a schematic perspective view showing a further manipulation step of the locking mechanism the present invention.

FIG. 7. is an alternative embodiment of the locking mechanism according to the present invention.

FIG. 8. is a schematic perspective view showing the manipulation of the alternative locking mechanism of the present invention.

### DETAILED DESCRIPTION OF THE PREFERRED EMBODIMENTS

Reference will now be made in detail to the preferred embodiments of the present invention; examples of which are illustrated in the accompanying drawings.

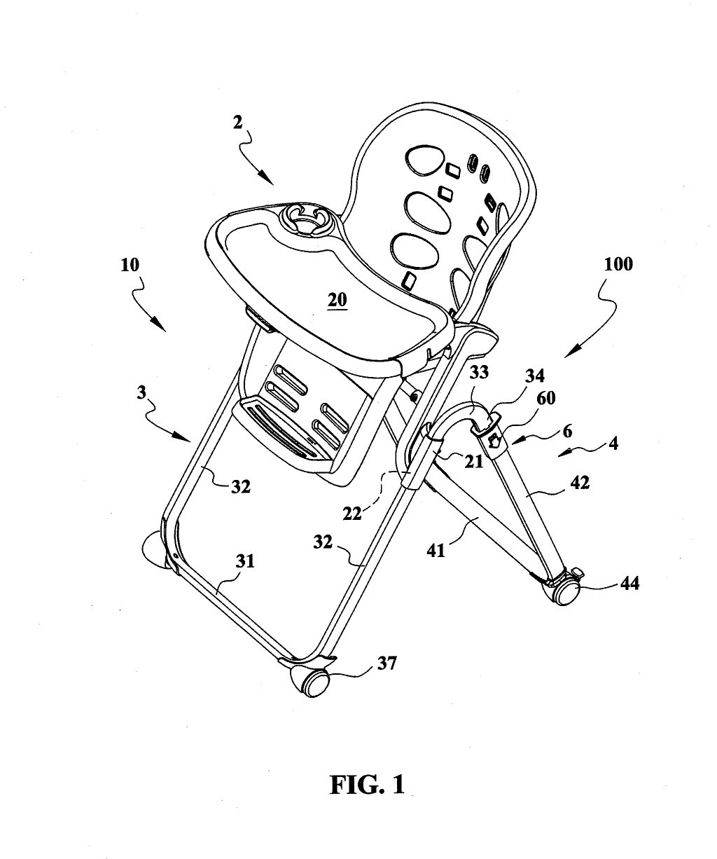

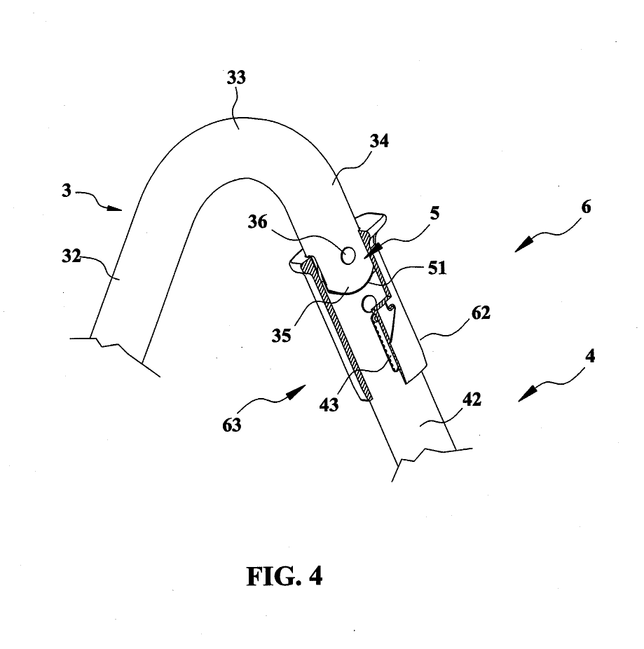

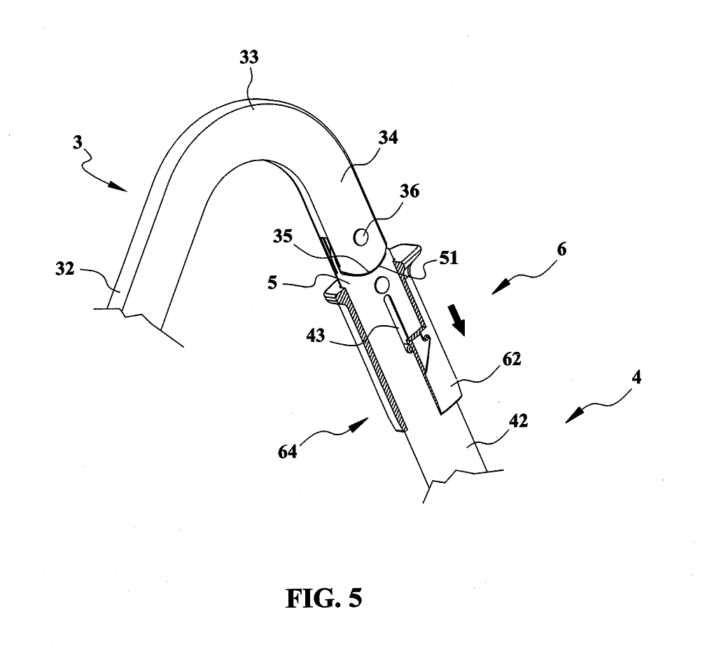

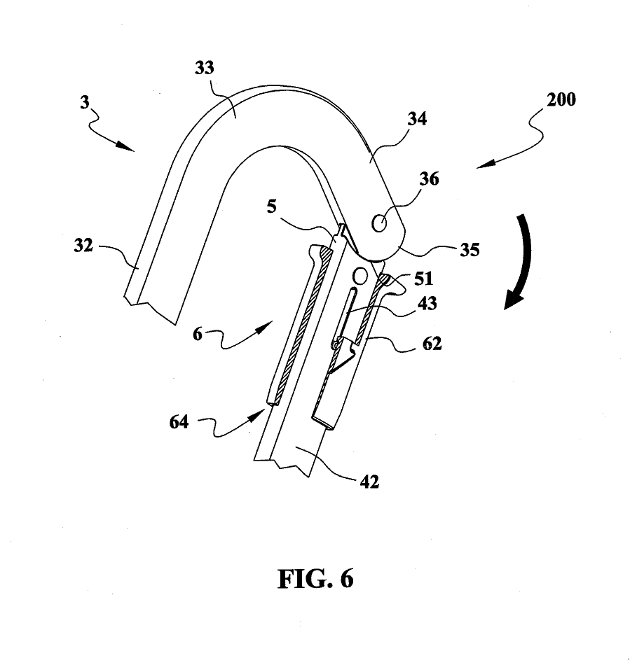

Referring to FIGS. 1 to 8, two embodiments of the foldable baby carrier support 10 according to the present invention similarly include a front rack 3, a rear rack 4 and a locking mechanism 6, 7. The front rack 3 has a pair of front side struts 32 extending through a front side of the foldable baby carrier support 10; the pair of front side struts 32 each has a rear downward extension 34 bended from the front side to the rear side of the foldable baby carrier support 10, and the rear downward extensions 34 each has a pivot portion 36 at its distal end.

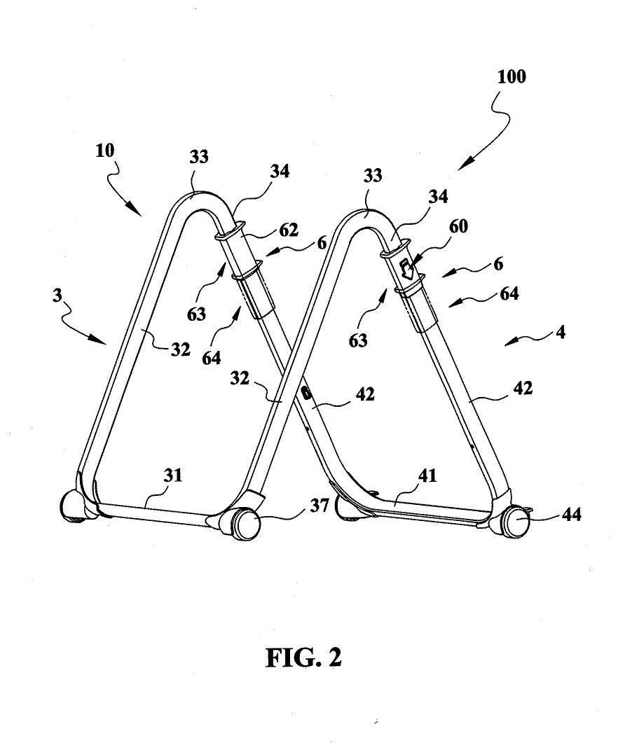

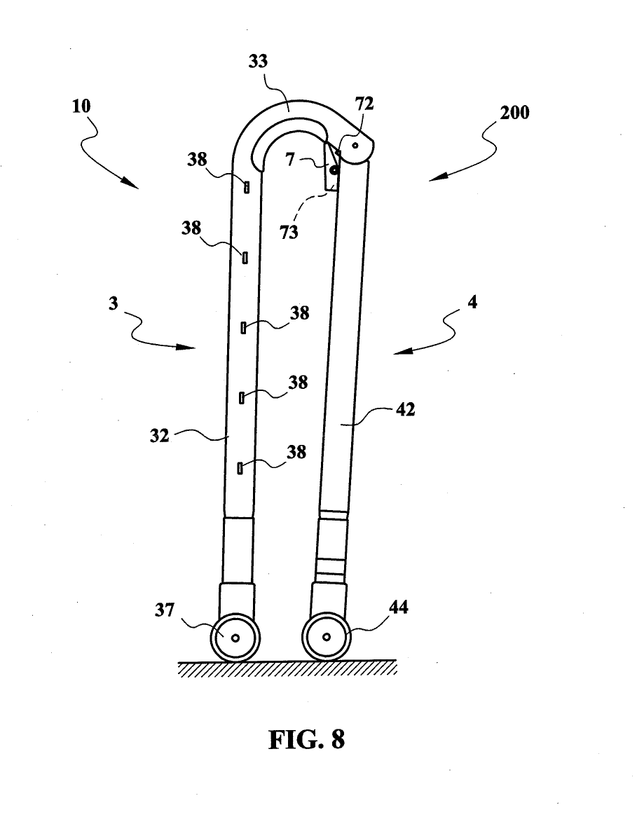

The rear rack 4 has a pair of rear side struts 42; the pair of rear side struts 42 each is equipped with a pivot mounts 5 for pivoting the rear downward extensions 34 at the pivot portions 36. The locking mechanism 6, 7 is adopted to lock and unlock the pivot mounts 5 so as to lock the foldable baby carrier support 10 in an erected configuration 100 as shown in FIGS. 1 and 2, and unlock the foldable baby carrier support 10 to be foldable into a folded configuration 200 as shown in FIG. 8.

The foldable baby carrier support 10 are mainly adopted to support a baby carrier, preferably, to permit a chair 2 slidably mounted to the front rack 3. Referring to FIG. 1, the chair 2 may further equipped with a food plate 20, two sliding mount 21 and two positioning elements 22. The sliding mounts 21 may slidably sleeve on the front side struts 32 for support the chair 2 at variant heights.

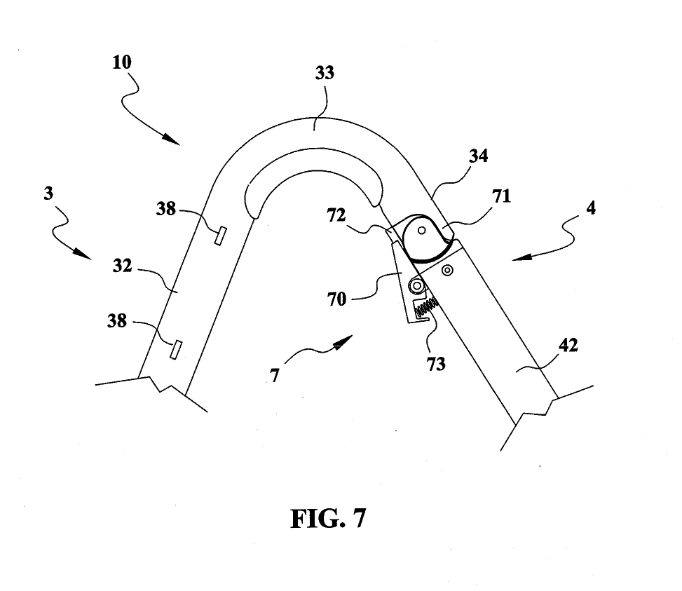

Referring to FIGS. 1 and 7, the positioning elements 22 may engage with positioning holes 38 formed on the front side struts 32 so as to position the sliding mounts 21 along the front side of the foldable baby carrier support 10.

Referring to FIGS. 2 to 6, the locking mechanism 6 may include a pair of retractable bushes 62 slidably sleeved on the pivot mounts 5 respectively. The retractable bushes 62 each has a first position 63 to sleeve on the rear downward extension 34 in a length so as to lock the foldable baby carrier support 10 in the erected configuration 100, and a second position 64 to release the rear downward extension 34.

For retaining and limiting the movement of the retractable bushes 62 while to slide reciprocally between the first position 63 and the second position 64, the rear side struts 42 each may be formed with an elongated slot (43) thereby to allow a pin to insert therethrough so as to slidably connect the retractable bushes 62 to the rear side struts 42.

Referring to FIGS. 1 and 2, the foldable baby carrier support 10 is selectively to further include a pair of front wheels 37 attached to the under side of the front rack 3, and a pair of rear wheels 44 attached to the under side of the rear rack 4.

The front rack 3 may further include a transverse strut 31 connected the pair of front side struts 32 or formed integrally with the pair of front side struts 32 as substantially a U-shaped metal frame. In the same concept, the pair of rear side struts 42 may also include a rear transverse strut 41 connected or formed integrally with the two rear side struts 42.

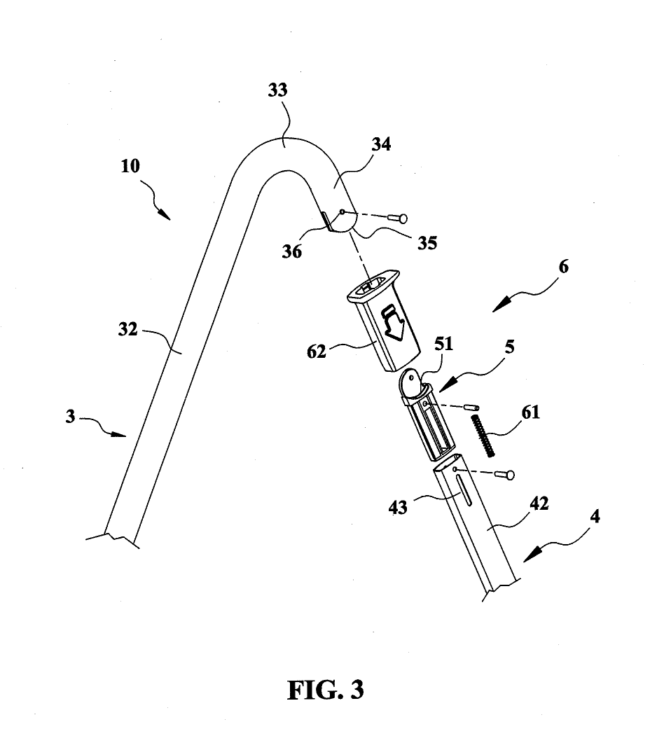

Referring to FIGS. 3 to 6, front side struts 32 have two curved section 33 formed integrally with the rear downward extensions 34. The rear downward extensions 34 each may be formed with a curved edge 35 at its distal end, and the pair of pivot mounts 5 each may be formed with a curved indent 51 contoured with the curved edge 35.

Preferably, the pair of retractable bushes 62 each may be biased by a spring 61 toward the first position 63 so as to normally sleeve on the rear downward extension 34 in a length thereby locking the foldable baby carrier support 10 in the erected configuration 100.

Referring to FIGS. 7 and 8, an alternative embodiment of the locking mechanism 7 includes a side wall 71 and a protruded portion 72 formed on the rear downward extension 34 for limiting a maximal rotation of the rear rack 4 in a predetermined angle, so as to guide the rear rack 4 align to the rear downward extension 34.

In this alternative embodiment, the locking mechanism 7 also includes a pair of seesaw-like elements 70 pivoted on the rear side struts 42 and biased by a resilient element 73 to have one end thereof to abut against the protruded portion 72 thereby retaining the foldable baby carrier support 10 in the erected configuration 100.

When one end of the seesaw-like elements 70 is pushed against the resilient element 73, the opposite end would release from the protruded portion 72, by this way to release the rear side struts 42 to rotate, thereby folding the foldable baby carrier support 10 into folded configuration 200 as shown in FIG. 8.

As the rear downward extension 34 is bended from the front side to the rear side, the pivot portion 36 has a distance away from the front rack 3, this could use to prevent the front rack 3 and the rear rack 4 from clamping like a scissors to cut the user's hand and fingers.

While particular embodiments of the invention have been described, those skilled in the art will recognize that many modifications are possible that will achieve the same goals by substantially the same system, device or method, and where those systems, devices or methods still fall within the true spirit and scope of the invention disclosed.

What is claimed is:

1. A foldable baby carrier support (10), including:
a front rack (3), having a pair of front side struts (32) extending through a front side of the foldable baby carrier support (10), wherein the pair of front side struts (32) each has a rear downward extension (34) bended from the front side to a rear side of the foldable baby carrier support (10), and the rear downward extensions (34) each has a pivot portion (36) at a distal end thereof;
a rear rack (4), having a pair of rear side struts (42); the pair of rear side struts (42) each equipped with a pair of pivot mounts (5) for pivoting the rear downward extensions (34) at the pivot portions (36); and
a locking mechanism (6, 7), adopted to lock and unlock the pivot mounts (5) so as to lock the foldable baby carrier support (10) in an erected configuration (100), and unlock the foldable baby carrier support (10) to be foldable into a folded configuration (200).

2. The foldable baby carrier support (10) of claim 1, wherein the locking mechanism (6) includes a pair of retractable bushes (62) slidably sleeved on the pivot mounts (5) respectively, wherein the retractable bushes (62) each has a first position (63) to sleeve on the rear downward extension (34) in a length so as to lock the foldable baby carrier support (10) in the erected configuration (100), and a second position (64) to release the rear downward extension (34).

3. The foldable baby carrier support (10) of claim 1, further includes a pair of front wheels (37) attached under the front rack (3), and a pair of rear wheels (44) attached under the rear rack (4).

4. The foldable baby carrier support (10) of claim 1, wherein the front rack (3) further includes a transverse strut (31) connected the pair of front side struts (32).

5. The foldable baby carrier support (10) of claim 1, wherein the front rack (3) has two curved section (33) formed integrally with the rear downward extensions (34) and the front side struts (32).

6. The foldable baby carrier support (10) of claim 1, wherein the rear downward extensions (34) each is formed with a curved edge (35) at a distal end thereof.

7. The foldable baby carrier support (10) of claim 6, wherein the pair of pivot mounts (5) each is formed with a curved indent (51) contoured with the curved edge (35).

8. The foldable baby carrier support (10) of claim 2, wherein pair of retractable bushes (62) each is biased by a spring (61) toward the first position (63) so as to normally sleeve on the rear downward extension (34) in a length thereby locking the foldable baby carrier support (10) in the erected configuration (100).

9. The foldable baby carrier support (10) of claim 1, wherein the rear downward extension (34) is formed with a side wall (71) for limiting the rotation of the rear rack (4) within a maximal angle, so as to guide the rear rack (4) align to the rear downward extension (34).

10. The foldable baby carrier support (10) of claim 1, wherein the rear downward extensions (34) each is formed with a protruded portion (72), and the locking mechanism (7) includes a pair of seesaw-like elements (70) each pivoted on one of the rear side struts (42) and being biased by a resilient element (73) to abut against the protruded portion (72) thereby retaining the foldable baby carrier support (10) in the erected configuration (100); when one end of the seesaw-like elements (70) is pushed against the resilient element (73), another end of the seesaw-like elements (70) would release from the protruded portion (72) that permits the rear side struts (42) to rotate and fold the foldable baby carrier support (10) into the folded configuration (200).
